(19) United States
(12) Patent Application Publication
(10) Pub. No.: US 2018/0114033 A1
(43) Pub. Date: Apr. 26, 2018

(54) CONTROLLED EXECUTION OF QUERIES FOR PROTECTING SENSITIVE DATA IN QUERY RESPONSES IN AN ON-DEMAND SERVICES ENVIRONMENT

(71) Applicant: salesforce.com, inc., San Francisco, CA (US)

(72) Inventor: ROHITASHVA MATHUR, Walnut Creek, CA (US)

(21) Appl. No.: 15/298,508

(22) Filed: Oct. 20, 2016

(51) Int. Cl. G06F 21/62; G06F 17/30

(52) U.S. Cl. CPC G06F 21/6227; G06F 17/3043; G06F 17/30867

(57) ABSTRACT

In accordance with embodiments, there are provided mechanisms and methods for facilitating controlled execution of queries for protecting sensitive data in query responses in an on-demand services environment according to one embodiment. In one embodiment and by way of example, a method analyzing, by a first computing device in the database environment, a first query requesting data from a database in the database environment, where the database includes sensitive data and non-sensitive data. The method may further include determining, by the first computing device, that the first query includes a request for sensitive data and non-sensitive data, and converting, by the first computing device, the first query into a second query such that the second query is limited to requesting the non-sensitive data. The method may further include generating, by the first computing device, a response to the second query such that the response includes the non-sensitive data and excludes the sensitive data.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

One or more implementations relate generally to data management and, more specifically, to facilitating controlled execution of queries for protecting sensitive data in query responses in an on-demand services environment.

### BACKGROUND

Databases are commonly used to store large amounts of data. As the amount of data increase, so too does the amount of sensitive data. When it comes to sensitive data, a single data breach can seriously impact a service provider's business, including loss of trust and business. It is, therefore, contemplated that efforts have been made to protect customer data; however, conventional techniques are merely limited to preventing unauthorized access to system.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request. The secure and efficient retrieval of accurate information and subsequent delivery of this information to the user system has been and continues to be a goal of administrators of database systems. Unfortunately, conventional database approaches are associated with various limitations.

### BRIEF DESCRIPTION OF THE DRAWINGS

In the following drawings like reference numbers are used to refer to like elements. Although the following figures depict various examples, one or more implementations are not limited to the examples depicted in the figures.

FIG. 1 illustrates a system having a computing device employing query data protection mechanism according to one embodiment;

FIG. 2 illustrates a query data protection mechanism according to one embodiment;

FIG. 3 illustrates a transaction sequence for facilitating protection of sensitive data according to one embodiment;

FIG. 4 illustrates a method for facilitating protection of sensitive data according to one embodiment;

FIG. 5 illustrates a computer system according to one embodiment;

FIG. 6 illustrates an environment wherein an on-demand database service might be used according to one embodiment; and

FIG. 7 illustrates elements of environment of FIG. 6 and various possible interconnections between these elements according to one embodiment.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

Methods and systems are provided for facilitating controlled execution and/or rewriting of queries for protecting sensitive data in query responses in an on-demand services environment.

Embodiments provide for safe access to data sources having mixed data (such as sensitive data and non-sensitive data), but allowing access, via Structured Query Language (SQL), to only the non-sensitive data. For example, in one embodiment, a controlled execution of select queries is provided against bind capture views and/or tables in a database to allow for selection of only those bind values that are deemed to be non-sensitive by extracting additional information from any original SQL queries or datasets to which the corresponding bind variables are known to belong.

As aforementioned, even a single data breach can lead to loss of business for a service provider (e.g., Salesforce.com®) and thus several attempts have been made to provide security; however, these conventional solutions are limited to simply denying unauthorized access to data or data sources. Conventional solutions are not smart-enough to differentiate between sensitive and non-sensitive data and thus, using such solutions leads to complete acceptance or denial of access to the system. This could further lead to the service provider having to remove access to certain data components, which can significantly impact its ability to identify and debug various issues or problems since many of the relevant data components might have been removed or not allow for accesses that can distinguish between data that could result in unauthorized access to the system versus data that would not.

Embodiments provide for a novel technique to allow for controlled accesses to mixed data (such as sensitive data and non-sensitive data) such that any sensitive data can be verifiably filtered out, leaving only the non-sensitive data to be included in query responses. For example, this novel technique allows for accessing data sources associated with mixed data (e.g., regular data and security tokens that can potentially be used to create un access session to the system), in the database using SQL, but allowing only the regular or non-sensitive data to be accessed.

It is contemplated that embodiments and their implementations are not merely limited to multi-tenant database system (“MTDBS”) and can be used in other environment, such as a client-server system, a mobile device, a personal computer (“PC”), a web services environment, etc. However, for the sake of brevity and clarity, throughout this document, embodiments are described with respect to a multi-tenant database system, such as Salesforce.com®, which is to be regarded as an example of an on-demand services environment. Other on-demand services environments include Salesforce® Exact Target Marketing Cloud™.

As used herein, a term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Embodiments are described with reference to an embodiment in which techniques for facilitating management of data in an on-demand services environment are implemented in a system having an application server providing a front end for an on-demand database service capable of supporting multiple tenants, embodiments are not limited to multi-tenant databases nor deployment on application servers. Embodiments may be practiced using other database architectures, i.e., ORACLE®, DB2® by IBM and the like without departing from the scope of the embodiments claimed.

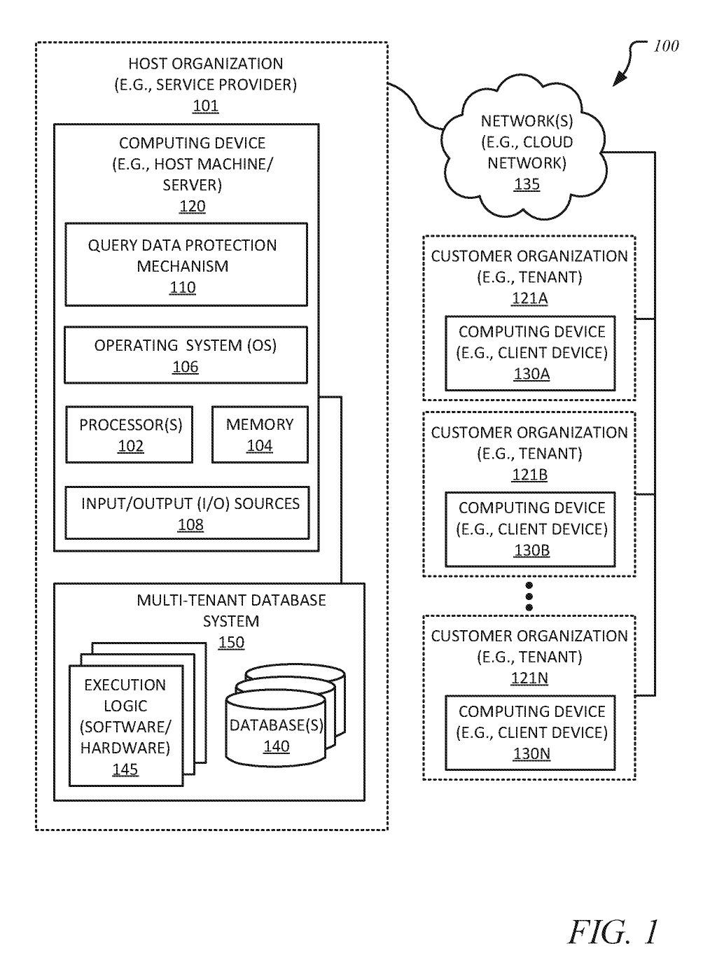

FIG. 1 illustrates a system 100 having a computing device 120 employing query data protection mechanism 110 according to one embodiment. In one embodiment, computing device 120 includes a host server computer serving a host machine for employing query data protection mechanism (“data protection mechanism”) 110 for facilitating controlled execution, including rewriting, of queries for generating selective query responses in a multi-tiered, multi-tenant, on-demand services environment.

It is to be noted that terms like “queue message”, “job”, “query”, “request” or simply “message” may be referenced interchangeably and similarly, terms like “job types”, “message types”, “query type”, and “request type” may be referenced interchangeably throughout this document. It is to be further noted that messages may be associated with one or more message types, which may relate to or be associated with one or more customer organizations, such as customer organizations 121A-121N, where, as aforementioned, throughout this document, “customer organizations” may be referred to as “tenants”, “customers”, or simply “organizations”. An organization, for example, may include or refer to (without limitation) a business (e.g., small business, big business, etc.), a company, a corporation, a non-profit entity, an institution (e.g., educational institution), an agency (e.g., government agency), etc.), etc., serving as a customer or client of host organization 101 (also referred to as “service provider” or simply “host”), such as Salesforce.com®, serving as a host of data protection mechanism 110.

Similarly, the term “user” may refer to a system user, such as (without limitation) a software/application developer, a system administrator, a database administrator, an information technology professional, a program manager, product manager, etc. The term “user” may further refer to an end-user, such as (without limitation) one or more of customer organizations 121A-N and/or their representatives (e.g., individuals or groups working on behalf of one or more of customer organizations 121A-N), such as a salesperson, a sales manager, a product manager, an accountant, a director, an owner, a president, a system administrator, a computer programmer, an information technology (“IT”) representative, etc.

Computing device 120 may include (without limitation) server computers (e.g., cloud server computers, etc.), desktop computers, cluster-based computers, set-top boxes (e.g., Internet-based cable television set-top boxes, etc.), etc. Computing device 120 includes an operating system (“OS”) 106 serving as an interface between one or more hardware/physical resources of computing device 120 and one or more client devices 130A-130N, etc. Computing device 120 further includes processor(s) 102, memory 104, input/output (“I/O”) sources 108, such as touchscreens, touch panels, touch pads, virtual or regular keyboards, virtual or regular mice, etc.

In one embodiment, host organization 101 may further employ a production environment that is communicably interfaced with client devices 130A-N through host organization 101. Client devices 130A-N may include (without limitation) customer organization-based server computers, desktop computers, laptop computers, mobile computing devices, such as smartphones, tablet computers, personal digital assistants, e-readers, media Internet devices, smart televisions, television platforms, wearable devices (e.g., glasses, watches, bracelets, smartcards, jewelry, clothing items, etc.), media players, global positioning system-based navigation systems, cable setup boxes, etc.

In one embodiment, the illustrated multi-tenant database system 150 includes database(s) 140 to store (without limitation) information, relational tables, datasets, and underlying database records having tenant and user data therein on behalf of customer organizations 121A-N (e.g., tenants of multi-tenant database system 150 or their affiliated users). In alternative embodiments, a client-server computing architecture may be utilized in place of multi-tenant database system 150, or alternatively, a computing grid, or a pool of work servers, or some combination of hosted computing architectures may be utilized to carry out the computational workload and processing that is expected of host organization 101.

The illustrated multi-tenant database system 150 is shown to include one or more of underlying hardware, software, and logic elements 145 that implement, for example, database functionality and a code execution environment within host organization 101. In accordance with one embodiment, multi-tenant database system 150 further implements databases 140 to service database queries and other data interactions with the databases 140. In one embodiment, hardware, software, and logic elements 145 of multi-tenant database system 130 and its other elements, such as a distributed file store, a query interface, etc., may be separate and distinct from customer organizations (121A-121N) which utilize the services provided by host organization 101 by communicably interfacing with host organization 101 via network(s) 135 (e.g., cloud network, the Internet, etc.). In such a way, host organization 101 may implement on-demand services, on-demand database services, cloud computing services, etc., to subscribing customer organizations 121A-121N.

In some embodiments, host organization 101 receives input and other requests from a plurality of customer organizations 121A-N over one or more networks 135; for example, incoming search queries, database queries, application programming interface (“API”) requests, interactions with displayed graphical user interfaces and displays at client devices 130A-N, or other inputs may be received from customer organizations 121A-N to be processed against multi-tenant database system 150 as queries via a query interface and stored at a distributed file store, pursuant to which results are then returned to an originator or requestor, such as a user of client devices 130A-N at any of customer organizations 121A-N.

As aforementioned, in one embodiment, each customer organization 121A-N is an entity selected from a group consisting of a separate and distinct remote organization, an organizational group within host organization 101, a business partner of host organization 101, a customer organization 121A-N that subscribes to cloud computing services provided by host organization 101, etc.

In one embodiment, requests are received at, or submitted to, a web server within host organization 101. Host organization 101 may receive a variety of requests for processing by host organization 101 and its multi-tenant database system 150. For example, incoming requests received at the web server may specify which services from host organization 101 are to be provided, such as query requests, search request, status requests, database transactions, graphical user interface requests and interactions, processing requests to retrieve, update, or store data on behalf of one of customer organizations 121A-N, code execution requests, and so forth. Further, the web-server at host organization 101 may be responsible for receiving requests from various customer organizations 121A-N via network(s) 135 on behalf of the query interface and for providing a web-based interface or other graphical displays to one or more end-user client devices 130A-N or machines originating such data requests.

Further, host organization 101 may implement a request interface via the web server or as a stand-alone interface to receive requests packets or other requests from the client devices 130A-N. The request interface may further support the return of response packets or other replies and responses in an outgoing direction from host organization 101 to one or more client devices 130A-N.

It is to be noted that any references to software codes, data and/or metadata (e.g., Customer Relationship Model (“CRM”) data and/or metadata, etc.), tables (e.g., custom object table, unified index tables, description tables, etc.), computing devices (e.g., server computers, desktop computers, mobile computers, such as tablet computers, smartphones, etc.), software development languages, applications, and/or development tools or kits (e.g., Force.com®, Force.com Apex™ code, JavaScript™, jQuery™, Developerforce™, Visualforce™, Service Cloud Console Integration Toolkit (“Integration Toolkit” or “Toolkit”), Platform on a Service™ (“PaaS”), Chatter® Groups, Sprint Planner®, MS Project®, etc.), domains (e.g., Google®, Facebook®, LinkedIn®, Skype®, etc.), etc., discussed in this document are merely used as examples for brevity, clarity, and ease of understanding and that embodiments are not limited to any particular number or type of data, metadata, tables, computing devices, techniques, programming languages, software applications, software development tools/kits, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, “multi-tenant on-demand data system”, and the like, may be used interchangeably throughout this document. It is to be further noted that terms like “code”, “software code”, “application”, “software application”, “program”, “software program”, “package”, “software code”, “code”, and “software package” may be used interchangeably throughout this document. Moreover, terms like “job”, “input”, “request”, and “message” may be used interchangeably throughout this document.

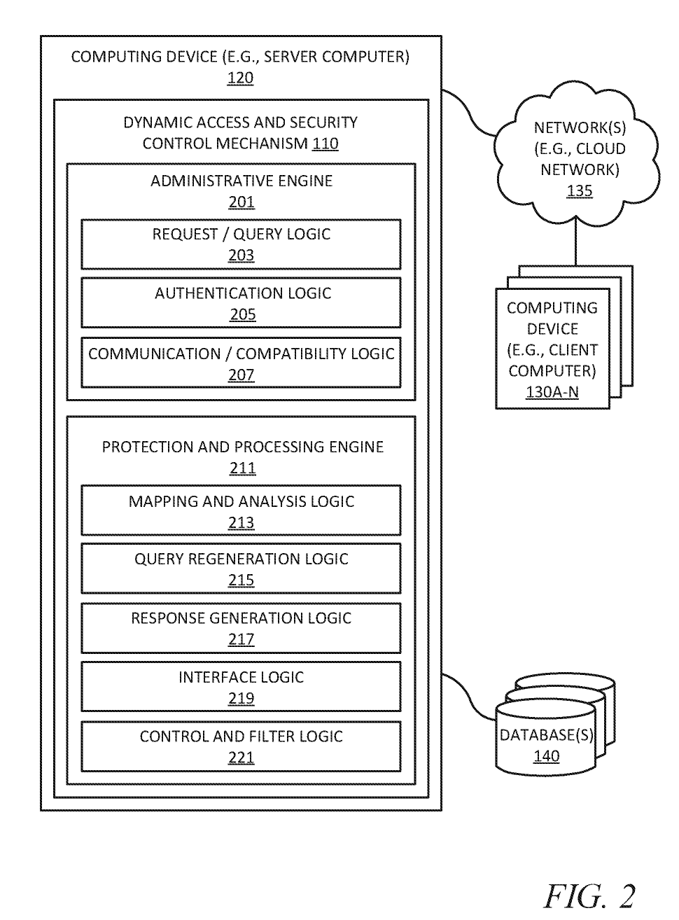

FIG. 2 illustrates a query data protection mechanism 110 according to one embodiment. In one embodiment, data protection mechanism 110 may include any number and type of components, such as administration engine 201 having (without limitation): request/query logic 203; authentication logic 205; and communication/compatibility logic 207. Similarly, data protection mechanism 110 may further include protection and processing engine 211 including (without limitation): mapping and analysis logic 213; query regeneration logic 215; response generation logic 217; and interface logic 219.

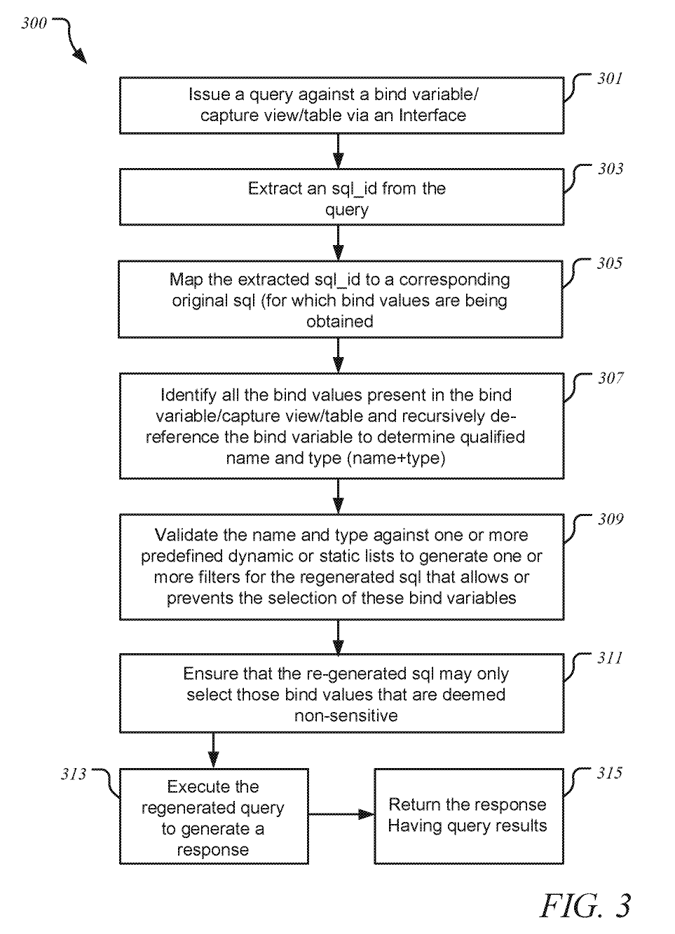

In one embodiment, computing device 120 may serve as a service provider core (e.g., Salesforce.com® core) for hosting and maintaining data protection mechanism 110 and be in communication with one or more database(s) 140, one or more client computers 130A-N, over one or more network(s) 135, and any number and type of dedicated nodes as will be further described with reference to FIG. 3.

Throughout this document, terms like “framework”, “mechanism”, “engine”, “logic”, “component”, “module”, “tool”, and “builder” may be referenced interchangeably and include, by way of example, software, hardware, and/or any combination of software and hardware, such as firmware. Further, any use of a particular brand, word, or term, such as “data protection”, “sensitive data”, “non-sensitive data”, “controlled execution or rewriting of queries”, “filtering of sensitive data”, “mapping”, “SQL”, “SQL_ID”, “bind variable”, “bind value”, “security token”, “regeneration”, “rewriting”, “table”, “view”, etc., should not be read to limit embodiments to software or devices that carry that label in products or in literature external to this document.

As aforementioned, with respect to FIG. 1, any number and type of requests and/or queries may be received at or submitted to request/query logic 203 for processing. For example, incoming requests may specify which services from computing device 120 are to be provided, such as query requests, search request, status requests, database transactions, graphical user interface requests and interactions, processing requests to retrieve, update, or store data, etc., on behalf of one or more client devices 130A-N, code execution requests, and so forth.

In one embodiment, computing device 120 may implement request/query logic 203 to serve as a request/query interface via a web server or as a stand-alone interface to receive requests packets or other requests from the client devices 130A-N. The request interface may further support the return of response packets or other replies and responses in an outgoing direction from computing device 120 to one or more client devices 130A-N.

Similarly, request/query logic 203 may serve as a query interface to provide additional functionalities to pass queries from, for example, a web service into the multi-tenant database system for execution against database(s) 140 and retrieval of customer data and stored records without the involvement of the multi-tenant database system or for processing search queries via the multi-tenant database system, as well as for the retrieval and processing of data maintained by other available data stores of the host organization's production environment. Further, authentication logic 205 may operate on behalf of the host organization, via computing device 120, to verify, authenticate, and authorize, user credentials associated with users attempting to gain access to the host organization via one or more client devices 130A-N.

In one embodiment, computing device 120 may include a server computer which may be further in communication with one or more databases or storage repositories, such as database(s) 140, which may be located locally or remotely over one or more networks, such as network(s) 235 (e.g., cloud network, Internet, proximity network, intranet, Internet of Things (“IoT”), Cloud of Things (“CoT”), etc.). Computing device 120 is further shown to be in communication with any number and type of other computing devices, such as client computing devices 130A-N, over one or more networks, such as network(s) 140.

In one embodiment, as illustrated, data protection mechanism 110 further includes protection and processing engine 211 to allow for a novel technique for protecting and securing sensitive data while accessing data sources having mixed data and processing queries requesting non-sensitive data and/or sensitive data. For example, once request/query logic 203 has detected or received a query from a user, associated with a tenant, over network 135, this query may then be forwarded on to mapping and analysis logic 213 for further processing. For example, the query may include a request for data, wherein this data may include any combination and amounts of sensitive data and non-sensitive data. For example, the data may be mixed data including non-sensitive information like sales reports for salespersons associated with a tenant, but this same data may also include sensitive information like social security numbers (SSNs) of these salesperson. As will be further described later, in one embodiment, data protection mechanism 110 provides for protection of that sort of sensitive data from being disclosed to others who are unauthorized to receive such information, where using protection and processing engine 211, this protection is intelligently offered through sensing and accessing both the sensitive and non-sensitive portions of the data.

For example, the known structure of tables and/or views holding bind variable values imply that the exact same sql, parameterized with sql_id, etc., is used to read the bind values without any formal means so as to not select and return bind values that may be holding security tokens and other sensitive data.

In one embodiment, a novel technique is provided where, for example, the issued sql is re-generated to include additional query filters that provably prevent selection of sensitive data. For example, upon receiving, as detected by request/query logic 203, the query may be analyzed, as facilitated by mapping and analysis logic 213, for its contents as well as the information that it is requesting in a response, where the analysis may further include mapping the contents of the query to already existing tables and views as provided by the original sql to determined whether any of the information being requested by the query includes sensitive data. For example, in one embodiment, mapping and analysis logic 213 uses the passed in sql_id to map it to the original sql, using it to recursively deference the bind variable to determine qualified name for the corresponding column and type and further, validate this name and type (e.g., name+type) against an existing list, such as dynamic or static blacklist or whitelist to generate one or more filters, as facilitated by regeneration logic 215, for the query, where the query is rewritten and/or the sql is regenerated, as facilitated by regeneration logic 215, to allow for or prevent the selection of this bind variable.

Subsequently, in one embodiment, response generation logic 217 is triggered to generate an appropriate response based on the assigned filters and/or the rewritten query so that the response does not contain any sensitive data or at least not without proper check and scrutiny and permission by protection and processing engine 211. It is contemplated that in some cases, certain sensitive data (e.g., date of birth, SSN, bank account number, etc.) may be included in a response, such as when this information is requested by those who are authorized to have access to such information, such as human resources management, accounting department management, government officials, etc.

This aforementioned complete or selectively partial removal of sensitive data from query responses is accomplished through associating selective filters to queries requesting such information and/or by simply rewriting such queries so that only selective information is included and removed. It is contemplated and as previously discussed, existing solutions are incapable of performing such tasks and thus, they are either inefficient or in some cases, out right risky.

For example, for various reasons, SQL queries are often parameterized in terms of substitution variables, called bind variables, which, as variables, assume different values at runtime. For debugging and identifying issues, in certain situations, it might be helpful to know the runtime value for a particular execution. In some cases, for example, runtime values may be assumed by these variables and linked with the corresponding sql_id, making them available using certain views and/or tables. Similarly, these views and/or tables may not provide mechanisms to discriminate selection of bind values based on whether the values represent sensitive data or not. As an example, a parameterized query that matches the password hash of a user against the stored hash value may have the hash of the passed in password show up in the bind views and/or tables and thus might be available for selection.

Referring back to data protection mechanism 110, a query, such as one placed by a user associated with a tenant, receive or detected by request/query logic 203 is forwarded on to protection and processing engine 211 for further processing. For example, this query may be received by mapping and analysis logic 213 of protection and processing engine 211 to determined whether the query is requesting any sensitive information, such as whether a response to the query might include anything content that may be regarded as sensitive.

There may be a number and type of ways in which this query may be mapped or analyzed by mapping and analysis logic 213, such as by mapping both the request contents of the query and/or any results contents of a potential response to the query with existing or historical information. For example, query and/or results contents may be mapped or run against certain lists, such as blacklists or whitelists, listing data that may be regarded as sensitive or non-sensitive, where these lists may be of static or dynamic in nature. For example, a static list may include information that is consistently regarded as sensitive (e.g., SSN), while a dynamic list may include information that may be periodically changing status from sensitive to non-sensitive (e.g., employee badge number) depending on the circumstances or requesting users or entities. Similarly, query and/or results contents may be mapped and/or matched to other similar datasets or data sources, such as tables and/or other such documents or files.

If mapping and analysis logic 213 determines that the query is not requesting any sensitive data, then the query may be allowed to proceed by having response generation logic 217 generate an appropriate response to the query and communication/compatibility logic 2207 to communicate the response to the user through an interface via a display screen of computing device 120 as facilitated by interface logic 219. It is contemplated that the interface is not limited to any particular number or type of interface, such as user interface (e.g., Web browser, Graphical User Interface (GUI), software application-based interface, etc.), application programming interface (API), Representational State Transfer (REST) or RESTful API, and/or the like.

If, however, mapping and analysis logic 213 determines that the query is requesting information that is regarded as sensitive data, then the analysis may be forwarded on to regeneration logic 215 for additional processing. In one embodiment, regeneration logic 215 may simply associate one or more filters with the query, such as a filter to remove all or redact portions of the sensitive data may be assigned to the query, where these one or more filters are then taken into consideration by response generation logic 217 to remove or redact portions of the sensitive data in accordance with or as prescribed by the one or more filters.

In another embodiment, regeneration logic 215 may simply regenerate or rewrite the entire or certain parts of the query. For example, the original query, as received by request/query logic 203, may be entirely or partially regenerated or rewritten by regeneration logic 215 so that it is only this newly regenerated or rewritten query is considered and executed by response generation logic 217 and accordingly, any response generated for the query may not include any of the sensitive data previously requested by the original query. Further, this response, having query results, is returned to the user through a display screen associated with computing device 120 and allowed to be accessed or manipulated by the user through the interface (e.g., user interface, such as a Web browser) as offered by the display screen.

It is contemplated that a tenant may include an organization of any size or type, such as a business, a company, a corporation, a government agency, a philanthropic or non-profit entity, an educational institution, etc., having single or multiple departments (e.g., accounting, marketing, legal, etc.), single or multiple layers of authority (e.g., C-level positions, directors, managers, receptionists, etc.), single or multiple types of businesses or sub-organizations (e.g., sodas, snacks, restaurants, sponsorships, charitable foundation, services, skills, time etc.) and/or the like.

Communication/compatibility logic 207 may facilitate the ability to dynamically communicate and stay configured with any number and type of software/application developing tools, models, data processing servers, database platforms and architectures, programming languages and their corresponding platforms, etc., while ensuring compatibility with changing technologies, parameters, protocols, standards, etc.

It is contemplated that any number and type of components may be added to and/or removed from data protection mechanism 110 to facilitate various embodiments including adding, removing, and/or enhancing certain features. It is contemplated that embodiments are not limited to any particular technology, topology, system, architecture, and/or standard and are dynamic enough to adopt and adapt to any future changes.

FIG. 3 illustrates a transaction sequence 300 for facilitating protection of sensitive data according to one embodiment. Transaction sequence 300 may be performed by processing logic that may comprise hardware (e.g., circuitry, dedicated logic, programmable logic, etc.), software (such as instructions run on a processing device), or a combination thereof. In one embodiment, transaction sequence 300 may be performed or facilitated by one or more components of data protection mechanism 110 of FIG. 2. The processes of transaction sequence 300 are illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-2 may not be repeated or discussed hereafter.

Transaction sequence 300 begins at block 301 with a query being issued through an interface (e.g., user interface, API, etc.) against a bind variable view/table, wherein the query is placed by a user having access to a client computing device offering interface (e.g., user interface, API, REST API, etc.), wherein the query may be received at a server computing device over a network, such as a cloud network, the Internet, etc. At block 303, in one embodiment, sql_id is extracted from the query, where, at block 305, this sql_id is mapped to the original sql for which bind values are to be identified and obtained. At block 307, the bind values present in the bind capture view/table are identified and recursively de-referenced to determine a qualified name for the corresponding column and type. At block 309, the determined name and type are validated against one or more prepared dynamic or static lists, such as a blacklist or a whitelist, to generate a filter for the re-generated sql that allows or prevents the selection of the relevant bind variables.

At block 311, the re-generated sql is now regarded as formally safe and only the select bind values are deemed to be non-sensitive data. At block 313, the regenerated or rewritten query is executed against the bind capture view/table in the relevant database, wherein execution of the query results in generation of a response to the query. At block 315, the response including the relevant results, without having any of the sensitive data, are returned to the user through the same or another interface at the same or another client computing device over the same or another network.

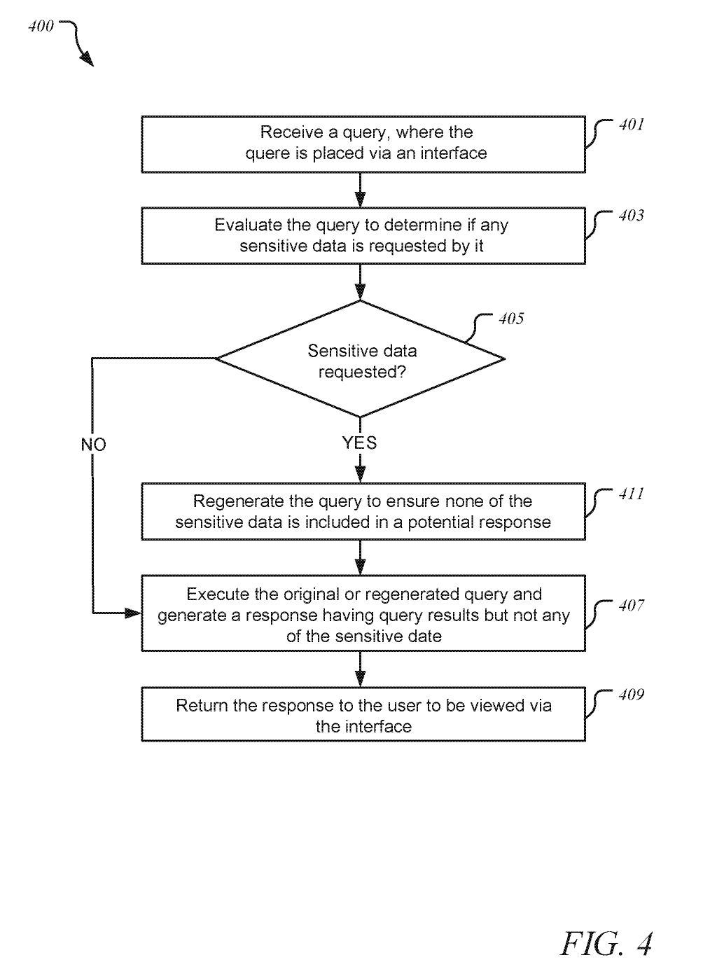

FIG. 4 illustrates a method 400 for facilitating protection of sensitive data according to one embodiment. Method 400 may be performed by processing logic that may comprise hardware (e.g., circuitry, dedicated logic, programmable logic, etc.), software (such as instructions run on a processing device), or a combination thereof. In one embodiment, method 400 may be performed or facilitated by one or more components of data protection mechanism 110 of FIG. 2. The processes of method 400 are illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-3 may not be repeated or discussed hereafter.

Method 400 begins at block 401 with receiving a query from a client computing device over a network, there the query may have been placed by a user having access to an interface (e.g., Web browser, other user interfaces, API, REST API, etc.) offered by the client computing device, where the user (e.g., sales director, system administrator, etc.) may be associated with or representing a tenant (e.g., business organization, government agency, etc.). At block 403, upon receive or detecting the query, it may be evaluated to determine whether the information requested by the query could potentially include any sensitive data (e.g., SSN, account numbers, birth dates, etc.). In one embodiment, this evaluation may include analyzing request contents of the query and any potential result contents and further, mapping the request and/or result contents to other historical contents, patterns, preferences, parameters or protocols, lists (e.g., blacklists, whitelists, etc.), and/or the like, that are capable of highlighting which data might or might not be regarded as sensitive.

At block 405, a determination is made as to whether the evaluation of the query indicates any potential inclusion of any sensitive data in query results. If no sensitive data is requested or to be included, at block 407, the query is executed and a response to the query is generated and subsequently, at block 409, the response, having the relevant query results but not any of the sensitive data, is returned to the user via the same or another interface at the same or another client computing device through the same or another network.

Referring back to block 405, if at least some sensitive data is expected to be included in the query results, then, at block 411, based on the evaluation of the query along with any other relevant information (such which sensitive data is likely to be included or which parts the query are identified as requesting sensitive data, etc.), the query is regenerated using one or more techniques, such as assignment of one or more filters to the query to filter out the sensitive data, rewriting certain parts of the query that are identified as requesting the sensitive data, or rewriting the entire query, etc.

At block 407, the regenerated query is executed and as a result, a response to the query is generated, where the response includes the relevant query results but not any of the sensitive data. At block 409, the response is returned to the user via the same or another interface at the same or another client computing device through the same or another network.

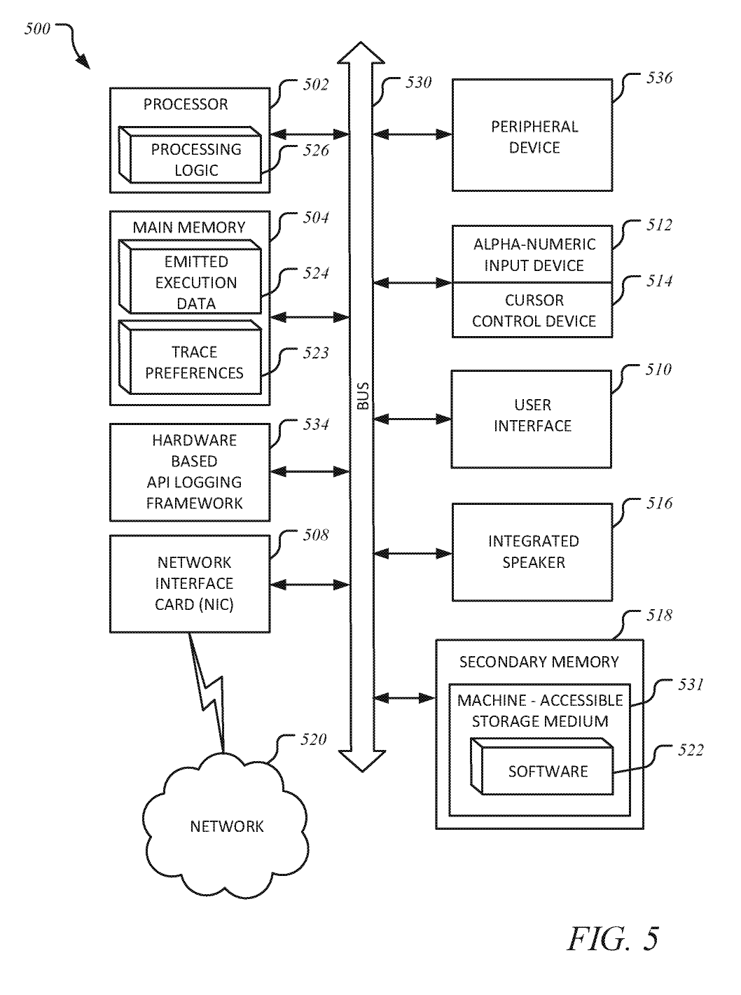

FIG. 5 illustrates a diagrammatic representation of a machine 500 in the exemplary form of a computer system, in accordance with one embodiment, within which a set of instructions, for causing the machine 500 to perform any one or more of the methodologies discussed herein, may be executed. Machine 500 is the same as or similar to computing devices 120, 130A-N of FIG. 1. In alternative embodiments, the machine may be connected (e.g., networked) to other machines in a network (such as host machine 120 connected with client machines 130A-N over network(s) 135 of FIG. 1), such as a cloud-based network, Internet of Things (IoT) or Cloud of Things (CoT), a Local Area Network (LAN), a Wide Area Network (WAN), a Metropolitan Area Network (MAN), a Personal Area Network (PAN), an intranet, an extranet, or the Internet. The machine may operate in the capacity of a server or a client machine in a client-server network environment, or as a peer machine in a peer-to-peer (or distributed) network environment or as a server or series of servers within an on-demand service environment, including an on-demand environment providing multi-tenant database storage services. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 500 includes a processor 502, a main memory 504 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 518 (e.g., a persistent storage device including hard disk drives and persistent multi-tenant data base implementations), which communicate with each other via a bus 530. Main memory 504 includes emitted execution data 524 (e.g., data emitted by a logging framework) and one or more trace preferences 523 which operate in conjunction with processing logic 526 and processor 502 to perform the methodologies discussed herein.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute the processing logic 526 for performing the operations and functionality of control mechanism 110 as described with reference to FIG. 1 and other Figures discussed herein.

The computer system 500 may further include a network interface card 508. The computer system 500 also may include a user interface 510 (such as a video display unit, a liquid crystal display (LCD), or a cathode ray tube (CRT)), an alphanumeric input device 512 (e.g., a keyboard), a cursor control device 514 (e.g., a mouse), and a signal generation device 516 (e.g., an integrated speaker). The computer system 500 may further include peripheral device 536 (e.g., wireless or wired communication devices, memory devices, storage devices, audio processing devices, video processing devices, etc. The computer system 500 may further include a Hardware based API logging framework 534 capable of executing incoming requests for services and emitting execution data responsive to the fulfillment of such incoming requests.

The secondary memory 518 may include a machine-readable storage medium (or more specifically a machine-accessible storage medium) 531 on which is stored one or more sets of instructions (e.g., software 522) embodying any one or more of the methodologies or functions of control mechanism 110 as described with reference to FIG. 1, respectively, and other figures discussed herein. The software 522 may also reside, completely or at least partially, within the main memory 504 and/or within the processor 502 during execution thereof by the computer system 500, the main memory 504 and the processor 502 also constituting machine-readable storage media. The software 522 may further be transmitted or received over a network 520 via the network interface card 508. The machine-readable storage medium 531 may include transitory or non-transitory machine-readable storage media.

Portions of various embodiments may be provided as a computer program product, which may include a computer-readable medium having stored thereon computer program instructions, which may be used to program a computer (or other electronic devices) to perform a process according to the embodiments. The machine-readable medium may include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions.

The techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment may be implemented using different combinations of software, firmware, and/or hardware.

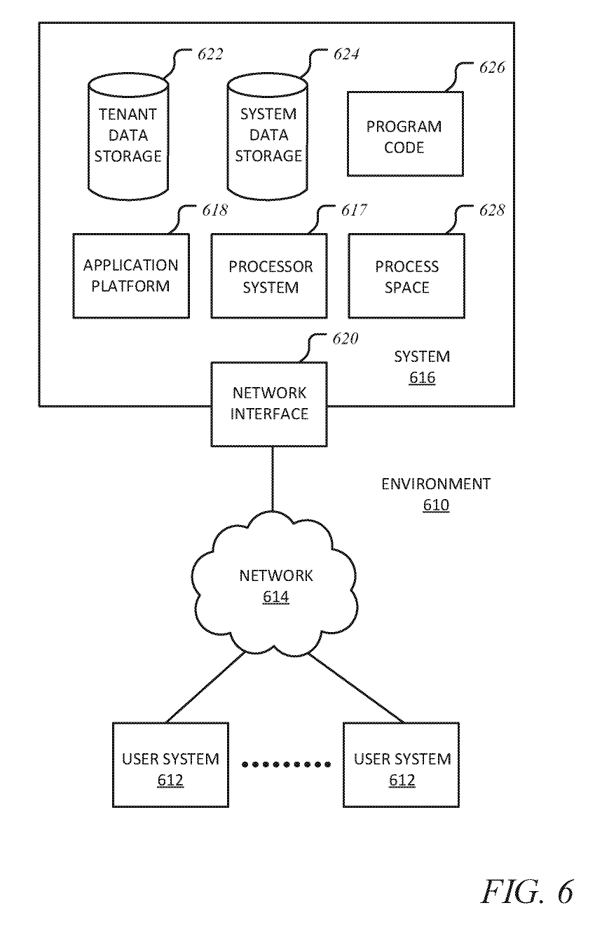

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

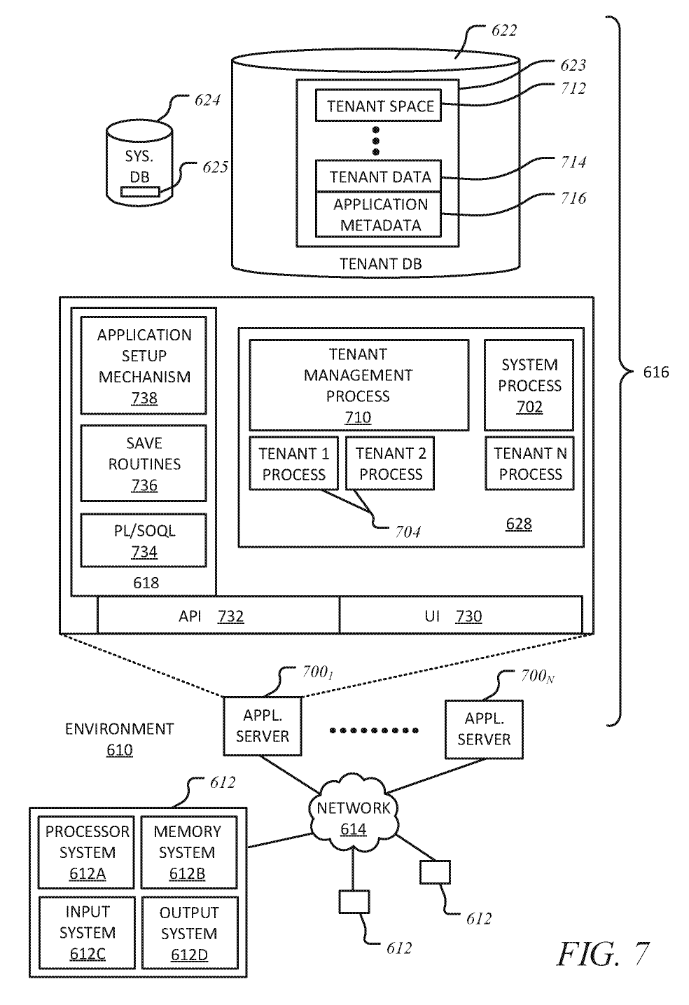

Environment 610 is an environment in which an on-demand database service exists. User system 612 may be any machine or system that is used by a user to access a database user system. For example, any of user systems 612 can be a handheld computing device, a mobile phone, a laptop computer, a workstation, and/or a network of computing devices. As illustrated in herein FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load-sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database-indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. User system 612 further includes Mobile OS (e.g., iOS® by Apple®, Android®, WebOS® by Palm®, etc.). Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Core® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™ JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 716 for the subscriber making the invocation and executing the metadata as an application in a virtual machine.

Each application server 700 may be communicably coupled to database systems, e.g., having access to system data 625 and tenant data 623, via a different network connection. For example, one application server 700₁ might be coupled via the network 614 (e.g., the Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 Big-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Any of the above embodiments may be used alone or together with one another in any combination. Embodiments encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive.

What is claimed is:

1. A method for protecting data in a database environment, the method comprising:
analyzing, by a first computing device in the database environment, a first query requesting data from a database in the database environment, wherein the database includes sensitive data and non-sensitive data;
determining, by the first computing device, that the first query includes a request for sensitive data and non-sensitive data;
converting, by the first computing device, the first query into a second query such that the second query is limited to requesting the non-sensitive data; and
generating, by the first computing device, a response to the second query such that the response includes the non-sensitive data and excludes the sensitive data.

2. The method of claim 1, wherein determining comprises checking potential results of the query to be included in the response with one or more datasets identifying the non-sensitive data, wherein the one or more datasets include one or more of historical results, predetermined lists, preferences, policies, and legal or ethical protocols.

3. The method of claim 1, wherein converting comprises assigning one or more filters to the first query to convert the first query into the second query, wherein the one or more filters to identify and filter out the sensitive data when the response is generated.

4. The method of claim 1, wherein converting comprises rewriting one or more portions or a whole of the first query into the second query, wherein the one or more portions are identified as one or more parts of a script of the first query requesting the sensitive data.

5. The method of claim 1, further comprising receiving, by the first computing device, the first query from a second computing device over a network, wherein the first and second computing devices are communicatively coupled over the network, and wherein the first computing device includes a server computing device and wherein the second computing device includes a client computing device.

6. The method of claim 1, further comprising transmitting, by the first computing device, the response to the second computing device, wherein the response is displayed at the second computing device using a display device, and wherein the query is placed and the response is accessed using an interface accessible to a user having access to the second computing device.

7. The method of claim 7, wherein the interface comprises one or more of a user interface, an application programming interface, and a Representational State Transfer (REST) API, wherein the user interface includes a Web browser.

8. A system comprising:
a processor and a memory to execute instructions at the system; and
a mechanism to:
analyze a first query requesting data from a database in the database environment, wherein the database includes sensitive data and non-sensitive data;
determine that the first query includes a request for sensitive data and non-sensitive data;
convert the first query into a second query such that the second query is limited to requesting the non-sensitive data; and
generate a response to the second query such that the response includes the non-sensitive data and excludes the sensitive data.

9. The system of claim 8, wherein determining comprises checking potential results of the query to be included in the response with one or more datasets identifying the non-sensitive data, wherein the one or more datasets include one or more of historical results, predetermined lists, preferences, policies, and legal or ethical protocols.

10. The system of claim 8, wherein converting comprises assigning one or more filters to the first query to convert the first query into the second query, wherein the one or more filters to identify and filter out the sensitive data when the response is generated.

11. The system of claim 8, wherein converting comprises rewriting one or more portions or a whole of the first query into the second query, wherein the one or more portions are identified as one or more parts of a script of the first query requesting the sensitive data.

12. The system of claim 8, wherein the mechanism is further to receive the first query from a computing device over a network, wherein the system and the computing device are communicatively coupled over the network, and wherein the system includes a server computing device and wherein the computing device includes a client computing device.

13. The system of claim 8, wherein the mechanism is further to transmit the response to the computing device, wherein the response is displayed at the computing device using a display device, and wherein the query is placed and the response is accessed using an interface accessible to a user having access to the computing device.

14. The system of claim 13, wherein the interface comprises one or more of a user interface, an application programming interface, and a Representational State Transfer (REST) API, wherein the user interface includes a Web browser.

15. A machine-readable medium comprising a plurality of instructions which, when executed by a processing device, cause the processing device to perform operations comprising:
analyzing a first query requesting data from a database in the database environment, wherein the database includes sensitive data and non-sensitive data;
determining that the first query includes a request for sensitive data and non-sensitive data;
converting the first query into a second query such that the second query is limited to requesting the non-sensitive data; and
generating a response to the second query such that the response includes the non-sensitive data and excludes the sensitive data.

16. The machine-readable medium of claim 15, wherein determining comprises checking potential results of the query to be included in the response with one or more datasets identifying the non-sensitive data, wherein the one or more datasets include one or more of historical results, predetermined lists, preferences, policies, and legal or ethical protocols.

17. The machine-readable medium of claim 15, wherein converting comprises assigning one or more filters to the first query to convert the first query into the second query, wherein the one or more filters to identify and filter out the sensitive data when the response is generated.

18. The machine-readable medium of claim 15, wherein converting comprises rewriting one or more portions or a whole of the first query into the second query, wherein the one or more portions are identified as one or more parts of a script of the first query requesting the sensitive data.

19. The machine-readable medium of claim 15, wherein the operations further comprise receiving the first query from a computing device over a network, wherein the processing and computing devices are communicatively coupled over the network, and wherein the processing device includes a server computing device and wherein the computing device includes a client computing device.

20. The machine-readable medium of claim 15, wherein the operations further comprise transmitting the response to the computing device, wherein the response is displayed at the computing device using a display device, and wherein the query is placed and the response is accessed using an interface accessible to a user having access to the computing device, wherein the interface comprises one or more of a user interface, an application programming interface, and a Representational State Transfer (REST) API, wherein the user interface includes a Web browser.
